(19) United States
(12) Patent Application Publication
(10) Pub. No.: US 2021/0321796 A1
(43) Pub. Date: Oct. 21, 2021

(54) HEALTHY HAND TOOL

(71) Applicant: Scott Fitzgerald, Center Moriches, NY (US)

(72) Inventor: Scott Fitzgerald, Center Moriches, NY (US)

(21) Appl. No.: 16/850,932

(22) Filed: Apr. 16, 2020

(51) Int. Cl. A47F 13/06

(52) U.S. Cl. CPC A47F 13/06

(57) ABSTRACT

A Healthy Hand Tool (HHT) that provides a device to help users to manipulate public items without requiring human touch is disclosed. The tool includes a poking tool having a top end and a bottom end, an open manipulation tool having a top edge, a bottom edge, and an opening in one side exposing a cavity, and a handle coupled to the bottom edge of the open manipulation tool. The poking tool extends away from the top edge of an open manipulation tool in the opposite direction of a handle, and the poking tool is coupled to the open manipulation tool along the top edge of the open manipulation tool at the back end of the top edge. The top edge of the open manipulation tool is coupled to the bottom end of the poking tool. The open manipulation tool has an oval shape with opposing straight sides running between the top edge and the bottom edge, and the opening in the open manipulation tool extends the majority of the length of an open side between the top edge and the bottom edge. The handle has a back edge member and a multi-curved finger grip coupled together at a base away from the open manipulation tool; the base of the handle includes a keyring hole and the back edge member and the poking tool are located on a common side of the device.

### TECHNICAL FIELD

This application relates in general to a device for providing a Healthy Hand Tool, and more specifically, to a device that helps users manipulate public items without requiring human touch.

### BACKGROUND

With viruses and other microbes being always present in the world, everyone is doing their best to eliminate their contact with germs and bacteria by using gloves, sanitizer, and anti-bacterial wipes. These items may not always be available during high demand times that may arise during a flu season or a pandemic. A user needs to go out into public spaces at least to go to a medical facility or a retail grocery establishment. These locations are places that large numbers of people must visit even when maintaining a social distance is needed to avoid transmission of airborne threats. Most individuals who visit these locations are required to touch or otherwise interact with the same items during their visit. These items thus become points of possible transfer of the viruses and other microbes from person to person.

Therefore, a need exists for a Healthy Hand Tool (HHT) that not only eliminates the threat above, but also aids in opening/closing doors, locking/unlocking doors, operating light switches, using public restrooms, assisting with holding onto a subway, bus, or train handles and poles, and operating elevator controls and other keypads. The HHT comes with a belt clip and a retractable style lanyard that can attach to your apparel, bag or keychain. The HHT is also coated in an anti-microbial material to help eliminate transmission of bacteria and viruses.

### SUMMARY

In accordance with the present invention, the above and other problems are solved by providing a Healthy Hand Tool, and more specifically, to a device that helps users manipulate public items without requiring human touch according to the principles and example embodiment disclosed herein.

In one embodiment, the present invention is a device for providing a device that helps users manipulate public items without requiring human touch. The tool includes a poking/prodding tool, a top end and a bottom end, an open manipulation tool with a top edge, a bottom edge, and an opening in one side exposing a cavity, and a handle coupled to the bottom edge of the open manipulation tool. The poking tool protrudes from the top edge of an open manipulation tool in the opposite direction of the handle, and the poking tool is coupled to the open manipulation tool at the back end of the manipulation tool's top edge. The top edge of the open manipulation tool is coupled to the bottom end of the poking tool. The open manipulation tool is an oval shape with opposing straight sides running between the top edge and the bottom edge, and the opening in the open manipulation tool extends the majority of the length of an open side between the top edge and the bottom edge. The handle has a back edge member and a multi-curved finger grip coupled together at a base away from the open manipulation tool, and the base of the handle includes a keyring hole. the back edge member and the poking tool are located on a common side of the device.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other items for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawing in which like reference numbers represent corresponding parts throughout:

FIG. 1 illustrates an example embodiment having multiple views for providing a device that helps users manipulate public items without requiring human touch according to the present invention.

### DETAILED DESCRIPTION

This application relates in general to a device for providing a Healthy Hand Tool, and more specifically, to a device that helps users manipulate public items without requiring human touch.

An embodiment of the present invention will be described in detail with reference to the drawing, wherein like reference numerals represent like parts and assemblies throughout the several views. Reference to this embodiment does not limit the scope of the invention, which is limited only by the scope of the claims attached hereto. Additionally, any example set forth in this specification are not intended to be limiting and merely set forth some of the many possible embodiments for the claimed invention.

In describing the embodiment of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures.

Unless otherwise indicated, all numbers used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing

The term “user” refers to an entity, e.g. a human, using the Healthy Hand Tool. The term user herein refers to one or more users.

The term “invention” or “present invention” refers to the invention being applied for via the patent application with the title “Healthy Hand Tool.” Invention may be used interchangeably with tool or HHT.

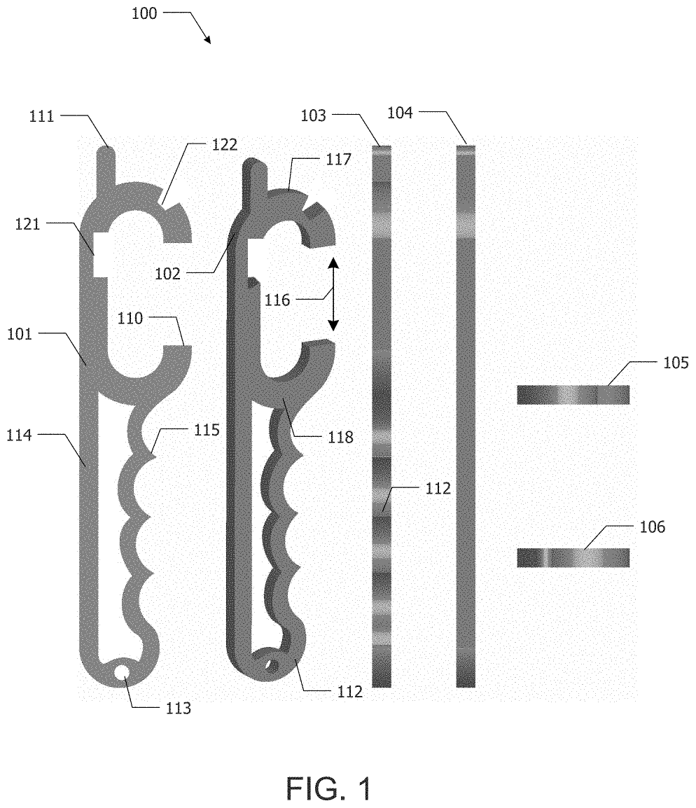

In general, the present disclosure describes a device for providing a Healthy Hand Tool (HHT). To better understand the present invention, FIG. 1 illustrates an example embodiment having multiple views for a device 100 that helps users manipulate public items and surfaces without requiring human touch according to the present invention. A profile view 101 of the tool 100 and a perspective view 102 both show the tool 100 having a handle 112, an open manipulation tool 110, and a poking tool 111. The handle 112 includes a keyring hole 113, a back edge member 114, and a multi-curved finger grip 115. The back edge member 114 and the multi-curved finger grip 115 both connect to the open manipulation tool 110 along a bottom edge and are coupled together at a base with a keyring hole 113.

The open manipulation tool 110 is an oval-shaped solid item having an opening 116 on one side of the oval that exposes a cavity within the open manipulation tool 110. The opening 116 represents the majority of an open side of the oval centered between a top edge 117 and a bottom edge 118. The poking tool 111 is coupled at the top edge 117 and extends away from the handle 112. A pair of notches are located within the upper manipulation tool 100. A first notch 121 is located along the inner flat surface and extends a portion of the length of the inner surface. In a preferred embodiment, the first notch is 7/16 inches in length and 3/16 inches deep. A second notch 122 is located along the outside shape of the open manipulation tool 100 along the outer curve of the oval. In a preferred embodiment, the second notch is ¼ inches in length at the outer edge and ⅛ inches in length at an inner edge that is centered within the outer edge of the second notch. inches deep.

The open manipulation tool 110 may be used to pick up or move items that fit within the opening 116 and are then within the inner oval. This open manipulation tool 110 may be used to operate door handles and similar fixtures that users encounter in public. The first notch 121 and the second notch 122 may be useful in embracing smaller elements of items that may be too small to be manipulated by the larger oval in the tool 100.

The handle 112 is connected to the open manipulation tool 110 at the bottom edge 118 of the oval. The opening 116 is positioned to be on the side of the tool 100 above the multi-curved finger grip 115. The back edge member 114 and multi-curved finger grip 115 have a common thickness. The handle is located along the bottom edge of the device such that the back edge member and the poking tool are located on a common side.

In a preferred embodiment, these items are ¼ inches think. In this preferred embodiment, the entire tool 100 has a length dimension of 7 ¼ inches from the top of the poking tool 111 to the keyring hole 113 in the handle 112 at the opposite end. The tool 100 has a top width dimension of 1 7/16 inches across the open manipulation tool 110 and a bottom width of 11/8 inches across the handle 112. The poking tool 111 extends a distance of ½ inches from the top edge 117 of the oval. A front side view 103 and a back side view 104 illustrate the thickness of the tool that preferably has a dimension of ¼ inches. A top view 105 and a bottom view 106 of the tool 100 is also included.

The HHT 100 is typically made from a rigid material such as plastic, hardwood, composite or metal and is coated in an anti- microbial material to help fight transmission of bacteria and viruses. This anti-microbial material is applied one time when manufactured when the tool 100 has paint applied during manufacture. The Tool 100 is typically sized to fit into a user's purse or pocket, although the tool may come in different sizes depending upon its expected use. The size of the opening 116 and the shape of the oval may also vary to other arrangements to be able to manipulate different-sized items.

Even though a particular combinations of features is recited in the present application, this combination is not intended to limit the disclosure of the invention. In fact, many of these features may be combined in ways not specifically recited in this application. In other words, any of the features mentioned in this application may be inclusive to this new invention in any combination or combinations to allow the functionality required for the desired operations. No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A device for providing an ability to manipulate items without touch, the hand tool comprises:
a poking tool having a top end and a bottom end;
an open manipulation tool having a top edge, a bottom edge, and an opening in one side exposing a cavity, the top edge of the open manipulation tool is coupled to a bottom end of the poking tool; and
a handle coupled to the bottom edge of the open manipulation tool.

2. The device according to claim 1, wherein the handle comprises a back edge member and a multi-curved finger grip coupled together at a base away from the open manipulation tool.

3. The device according to claim 2, wherein the base of the handle includes a keyring hole.

4. The device according to claim 1, wherein the poking tool extends away from the top edge of the open manipulation tool in the opposite direction of the handle.

5. The device according to claim 4, wherein the poking tool is coupled to the open manipulation tool along the top edge of the open manipulation tool at the back end of the top edge.

6. The device according to claim 5, wherein the handle comprises a back edge member and a multi-curved finger grip coupled together at a base away from the open manipulation tool in which the back edge member and the poking tool are located on a common side of the device.

7. The device according to claim 1, wherein the device is made of an anti-microbial material covering a solid base material providing a rigid device; the solid base material includes plastic, wood, composites, and metal.

8. The device according to claim 1, wherein the open manipulation tool has an oval shape with opposing straight sides running between the top edge and the bottom edge, and the opening in the open manipulation tool extends the majority of the length of an open side between the top edge and the bottom edge.

9. A device for providing an ability to manipulate items without touch, the device comprises:
a poking tool having a top end and a bottom end. The poking tool extends away from the top edge of an open manipulation tool in the opposite direction of a handle and the poking tool is coupled to the open manipulation tool along the top edge of the open manipulation tool at the back end of the top edge;
the open manipulation tool having a top edge, a bottom edge, an opening in one side exposing a cavity, a first notch along an inner edge of an oval created by the opening, and a second notch along an outer edge. The top edge of the open manipulation tool is coupled to the bottom end of the poking tool, the open manipulation tool has an oval shape with opposing straight sides running between the top edge and the bottom edge, and the opening in the open manipulation tool extends the majority of the length of an open side between the top edge and the bottom edge; and
a handle coupled to the bottom edge of the open manipulation tool. The handle comprises a back edge member and a multi-curved finger grip coupled together at a base away from the open manipulation tool; the base of the handle includes a keyring hole, and the back edge member and the poking tool are located on a common side of the device.

10. The device according to claim 9, wherein the device is made of an anti-microbial material covering a solid base material providing a rigid device. The solid base material includes plastic, wood, composites, and metal.
